(19) United States
(12) Patent Application Publication
(10) Pub. No.: US 2025/0190742 A1
(43) Pub. Date: Jun. 12, 2025

(54) INSTANCE NORMALIZATION IN MACHINE LEARNING MODELS USING LEARNED NORMALIZATION CONSTANTS

(71) Applicant: QUALCOMM Incorporated, San Diego, CA (US)

(72) Inventors: Manish Kumar SINGH, San Diego, CA (US); Hong CAI, San Diego, CA (US); Munawar HAYAT, San Diego, CA (US); Fatih Murat PORIKLI, San Diego, CA (US)

(21) Appl. No.: 18/537,144

(22) Filed: Dec. 12, 2023

(51) Int. Cl. G06N 3/02

(52) U.S. Cl. CPC G06N 3/02

(57) ABSTRACT

Certain aspects of the present disclosure provide techniques and apparatus for efficient inferencing using machine learning models and learned normalizing constants. An example method generally includes receiving an input for processing using a machine learning model. The input is normalized based on one or more defined constants associated with characteristics learned from a training data set used in training the machine learning model. An inference is generated for the input based on the normalized input, and one or more actions are taken based on the generated inference.

### INTRODUCTION

Aspects of the present disclosure relate to machine learning models.

Machine learning models may be used to process a variety of data, and various machine learning architectures have been used to provide solutions for a wide variety of computational problems. An assortment of machine learning model architectures exist, such as artificial neural networks (which may include convolutional neural networks (CNNs), recurrent neural networks (RNNs), deep neural networks, generative adversarial networks (GANs), etc.), random forest models, and the like. Increasingly, transformer neural networks are being used in a variety of image and video processing tasks, natural language processing, or other tasks in which data is processed in order to generate various inferences related to the data.

Machine learning models may be deployed on various devices, such as server computing systems, personal computing systems (e.g., laptop computers, desktop computers, etc.), and/or other computing systems on which machine learning models can be executed. However, because these machine learning models may include various computationally expensive components, the universe of devices on which these machine learning models can be deployed may be limited, and inferencing operations on devices on which these machine learning models are deployed may use significant amounts of available computing resources.

### BRIEF SUMMARY

Certain aspects provide a processor-implemented method. The method generally includes receiving an input for processing using a machine learning model. Instances of data associated with the received input are normalized based on one or more defined constants associated with characteristics learned from a training data set used in training the machine learning model. An inference is generated for the input based on the normalized instances of data, and one or more actions are taken based on the generated inference.

Certain aspects provide a processor-implemented method. The method generally includes generating a plurality of parameters for a machine learning model based on a training data set. Characteristics for one or more parameters from the plurality of parameters for the machine learning model are calculated. For each respective parameter of the one or more parameters, a corresponding characteristic is set as a constant for processing values of the respective parameter. The machine learning model is deployed. Generally, the machine learning model normalizes values generated for an input based on the constants.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example pipeline for efficiently processing data in a neural network based on normalization constants learned from a training data set, according to aspects of the present disclosure.

FIG. 2 illustrates example operations for training a machine learning model to generate normalized outputs based on learned normalization constants, according to aspects of the present disclosure.

FIG. 3 illustrates example operations for inferencing using a machine learning model to generate normalized outputs based on learned normalization constants, according to aspects of the present disclosure.

FIG. 4 depicts an example processing system configured to perform various aspects of the present disclosure.

FIG. 5 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for training and inferencing using machine learning models.

Various types of neural networks can be used to process visual content (e.g., detect objects, predict future motion of objects detected in visual content, segment visual content into different semantic groups, etc.), such as still images or streams of visual content (e.g., video content captured as a series of images at a given frame rate, such as 24 frames per second, 29.97 frames per second, 60 frames per second, etc.). However, these neural networks generally process visual content on a per-frame basis, which may be a computationally expensive process that increases in complexity as the frame size of each frame in the visual content increases.

Transformer neural networks (also referred to as “transformers”), and in particular vision transformers, have become increasingly common in a wide variety of machine learning tasks. Transformer-based architectures are generally configured to generate output based on a sequence of data (e.g., a sequence of frames in a video, a sequence of patches from a frame or image, and the like). Generally, machine learning models may use any number of transformer blocks (each providing self-attention), as well as any other components (e.g., one or more neural network layers).

In machine learning models such as transformer neural networks, various activation functions can be used to generate a normalized output from the transformer neural network. These activation functions may include, for example, a softmax activation function in which the output is scaled to values between −1 and 1 or other activation functions which can be used to restrict the output of the machine learning model to values between some defined minimum and maximum values. In many cases, these activation functions may be computationally expensive, and thus, to allow for machine learning models to be deployed on a wide variety of computing devices, various techniques can be used to eliminate, or at least reduce, the usage of such activation functions in a machine learning model.

One technique for inferencing that minimizes, or at least reduces, the computational expense of such inferencing may include normalizing an input prior to processing such an input using a layer of the machine learning model. However, normalization of an input may also be a computationally expensive process, as normalization of an input may entail processing each portion of a plurality of portions of the input in order to identify normalization factors and then scaling the input based on the identified normalization factors. The computational expense of normalizing the input may scale quadratically as the number of portions of the input increases (e.g., for an image, as the image resolution, and thus the number of tokens derived from the image, increases). Further, the scaling operations may involve various division operations, which may be performed based on polynomial approximation. Because polynomial approximation may also be a computationally expensive process, such approximation may further increase the computational expense of normalization operations performed on input data.

Still further, the amount of data involved in normalizing an input generally increases as the resolution of the input increases. As the resolution of the input increases, the amount of data may similarly increase and may exceed the amount of memory available for use in storing the input during inferencing operations. For example, the amount of data may exceed the amount of memory available on a processor on which inferencing operations are performed (e.g., may exceed the amount of cache on the processor). In such a case, data may be repeatedly swapped into and out of on-processor memory (also known as memory thrashing) while the input is normalized. Generally, while data involved in any particular operation is being swapped into on-processor memory (e.g., cache, memory registers, etc.), the processor may be unable to perform various operations until all the information involved in that particular operation is swapped into on-processor memory. In situations where the amount of on-processor memory is insufficient to hold the parameters and feature maps involved in an operation, the processor may repeatedly swap the parameters and feature maps into and out of on-processor memory, with each swap imposing hardware latency costs in the system.

Aspects of the present disclosure provide techniques for training and inferencing using machine learning models that normalize inputs based on learned normalizing statistics. As discussed in further detail below, learned normalizing statistics for inputs associated with one or more layers or other portions of a machine learning model may allow for these inputs to be normalized based on normalizing statistics learned from a training data set, as it may be assumed that inputs processed during inferencing operations may be within a range of data included in a training data set used to train the machine learning model. Because inputs can be normalized based on learned normalizing statistics, aspects of the present disclosure may allow for inputs to be normalized without incurring the computational expense of generating normalizing statistics over the inputs into the machine learning model and scaling inputs based on these input data set-specific normalizing statistics during inferencing. Thus, fewer compute resources may be utilized to complete various tasks for which machine learning models are used, such as object detection or other computer vision tasks. In turn, the techniques discussed herein may reduce the amount of power used by computing devices to perform these tasks and/or accelerate processing of inputs.

### Example Machine Learning Model Architecture with Input Normalization Using Learned Normalizing Constants

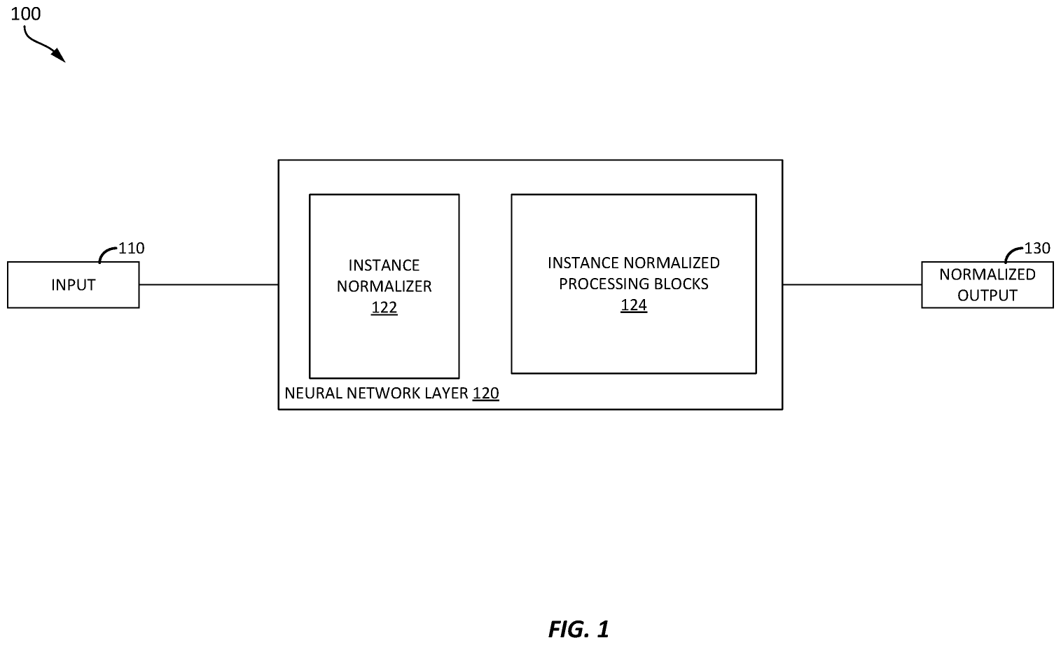

FIG. 1 illustrates an example machine learning model 100 in which an output of the machine learning model is generated based on inputs normalized based on learned normalizing constants, according to aspects of the present disclosure.

As illustrated in FIG. 1, the machine learning model 100 generates a normalized output 130 from an input 110 via a neural network layer 120. While FIG. 1 illustrates a single neural network layer 120, it should be recognized that the machine learning model 100 may include any number of neural network layers 120 that can be used to process an input using learned normalizing constants associated with each respective neural network layer 120. In some aspects, where the machine learning model 100 is a transformer neural network, the neural network layer 120 may be, for example, a self-attention layer in which inputs are linearly projected into queries Q, keys K, and values V, which may then be used to generate a set of features as an output. In some aspects, the neural network layer 120 may be a layer in a convolutional neural network.

The input 110 may be, for example, a multidimensional input, such as image data (in which the data has dimensions of H×W×C, where H corresponds to a height component, W corresponds to a width component, and C corresponds to a number of channels (e.g., color luminance channels, chrominance channels, etc.) in the image data), video data (in which the data has dimensions of H×W×C×T, where T corresponds to a temporal component), or the like.

In some aspects, the input 110 may be tokenized prior to processing using the neural network layer 120. In tokenizing the input 110, the input 110 may be converted from a multidimensional input into a one-dimensional array of tokens, with each token corresponding to a portion of the input. For example, if the input 110 is an image input into the neural network layer 120 for processing having dimensions of H×W×C, the tokenized version of the input may be divided into a plurality of tokens having dimensions smaller than H×W×C. Each token may be organized sequentially starting from a defined origin point in the input data so that the resulting tokenized version of the input can be sequentially reconstructed into the input 110.

The neural network layer 120 may include an instance normalizer 122, which may be configured to normalize instances of data associated with the input 110 based on normalizing constants learned from a training data set used to train the machine learning model 100. In some aspects, the instances of data normalized by the instance normalizer 122 may include data projected from the input 110, such as tokens in the query matrix Q and key matrix K in a layer of a transformer neural network derived from the input 110, an output of a prior layer of the neural network (generated directly or indirectly from the input 110), parameters within the neural network layer 120 (e.g., the learned β and γ parameter vectors, discussed in further detail below), or the like.

Generally, when the machine learning model 100 is trained, various statistical measurements (e.g., related to the query matrix Q, key matrix K, and learned β and γ parameter vectors) can be calculated from the training data set, such as a mean and a standard deviation of the data in the training data set. The normalizing constants may be, for example, represented as one or more learned parameter vectors of size N, where N corresponds to a number of tokens into which the input 110 is projected prior to processing using the neural network layer 120. In one example (e.g., in normalization based on linear curve fitting), these learned parameter vectors may include a vector γ, representing a scaling factor applied to tokens derived from the input 110, and a vector β, corresponding to an offset factor applied to tokens derived from the input 110. It should be recognized that other normalization techniques defined according to other polynomials may be used using other learned vectors. In some aspects, the normalizing constants may include the mean and standard deviation values derived from the data in the training data set, amongst other statistical measurements derived from the data in the training data set. In some aspects, the β and γ parameter vectors may be initialized randomly during the training process and learned while the machine learning model 100 is trained.

In examples in which the input 110 is projected into queries Q, keys K, and values V, the queries Q and keys K may be defined according to the expression Q, K ∈ [symbol] ^{B,N,D}, where B corresponds to a batch size, D corresponds to a number of dimensions in the input 110, and N corresponds to the number of tokens into which the input 110 is projected. Instances x in the queries Q and keys K may be normalized into normalized values y according to the equation:

$$y = \frac{x - E [ x ]}{\sqrt{Var [ x ] + ϵ}} * γ + β$$

where E [x] represents the mean of the training data set used to train the machine learning model 100, Var [x] represents the variance of the training data set used to train the machine learning model 100, and e represents a constant used to avoid a zero-value denominator in the above equation. In some aspects, the normalization of each instance x in the queries Q and keys K may be performed based on trained mean, variance, scaling factors, and offset factors, the normalization of each instance of x may be performed as a linear transformation with a fixed scaling and offset factor applied to an instance x. These linear transformations may be performed efficiently on a processor (e.g., a CPU, GPU, neural processing unit (NPU), etc.) on which the machine learning model 100 executes and may thus allow for inferencing that does not incur the computational overhead of normalization over instance-specific data (e.g., associated with the input 100 or otherwise derived therefrom).

Because the normalizing constants may be learned during training of the machine learning model 100, normalization may be performed by the input normalizer 122 at inference time using computationally inexpensive processes. For example, normalization performed according to the above equation may involve multiplication and addition using matrices defined a priori instead of matrices dynamically generated based on the input 110. Further, the E [x] and Var [x] terms in the equation above may be defined as constants within the machine learning model 100 and need not be calculated for each input 110 processed using the machine learning model (which, as discussed above, may be a computationally expensive process and may result in memory thrashing when the input is (or a processed version thereof becomes) larger than an amount of on-processor memory present on one or more processors used to process the input). Thus, normalization of the input 110 performed by the input normalizer 122 at inference time may be performed as an affine transformation that may be folded into the neural network layer 120 or may be performed (not illustrated) as part of generating an output of a preceding neural network layer.

In some aspects, as illustrated, the normalized input generated by the input normalizer 122 may be output to normalized input processing blocks 124 in the neural network layer 120 for processing. Generally, because the normalized input processing blocks 124 operate on normalized data, the resulting output may also be normalized. Thus, the machine learning model 100 may output a normalized output (e.g., 130) that need not be normalized using an activation function, such as (but not limited to) a softmax function, a sigmoid function, tanh (hyperbolic tangent) function, or the like. Because the machine learning model 100 may omit a softmax or other activation function, aspects of the present disclosure, as discussed, may allow for efficient inferencing, as the computationally expensive processes of normalizing input data based on statistical properties of the input data and of normalizing an output using various activation functions (e.g., a softmax function) may be omitted. That is, unlike techniques that perform normalization based on data set-specific statistical measurements (and are thus data-dependent at inference time), aspects of the present disclosure may reduce the computational expense involved in inferencing over normalized data by performing normalization based on learned statistical measurements that are fixed at inference time.

The output 130 generated by the neural network layer 120 may be used as an input into another layer of the machine learning model 100 or may be output (e.g., as a prediction) for use in one or more downstream processes (not illustrated in FIG. 1). For example, in an autonomous driving scenario, the output 130 may include predictions of the locations of objects (in a three-dimensional space) captured within an image, predictions of object movement, and the like. These predictions may be used to control the autonomous vehicle to avoid a collision with these objects. For example, these predictions may be used to generate various control signals to control the speed and direction of the autonomous vehicle so that the path along which the autonomous vehicle travels comprises a path that minimizes, or at least reduces, a likelihood of a collision with the one or more objects identified in an image. In other examples, where the machine learning model 100 is used to control a robot, the output 130 may include predictions of how the robot will interact with other objects within the robot's operating environment. These predictions may be used to control to robot to avoid, or at least mitigate the likelihood of, collisions with other objects occurring within the operating environment. In yet further examples, the output 130 generated by the neural network layer 120 may be used in image processing tasks to identify objects of interest in captured imagery for tracking, to identify different levels of compression to use in compressing video content, or the like. It should be recognized that the foregoing describes various examples of actions that may be performed based on the output 130 of a neural network layer 120, though, and other actions may be contemplated for other scenarios in which the machine learning model 100 is deployed.

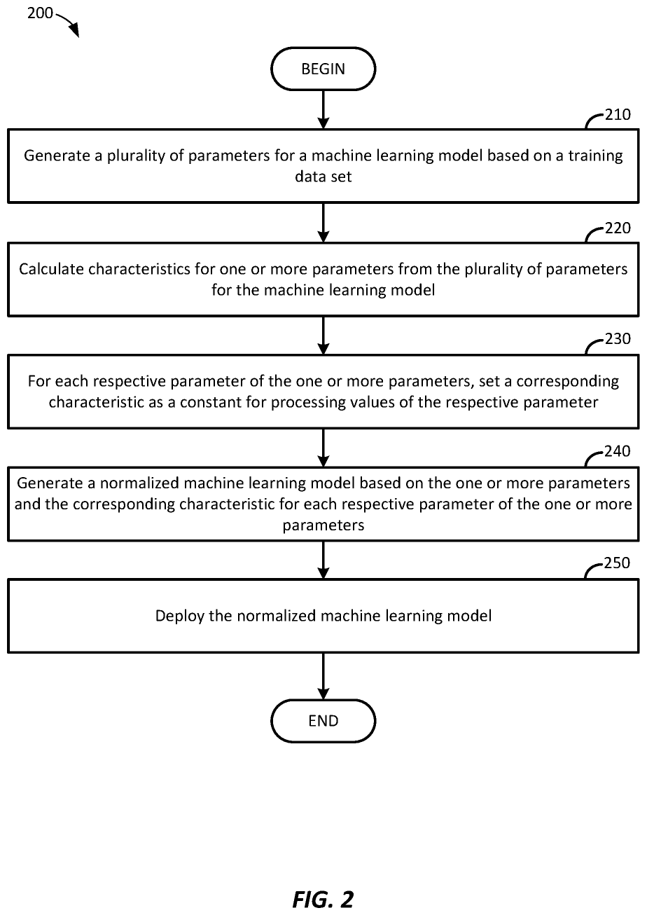

FIG. 2 illustrate example operations 200 for training a machine learning model to generate normalized outputs based on learned normalization constants, according to aspects of the present disclosure. The operations 200 may, for example, be used to generate the machine learning model 100 illustrated in FIG. 1.

As illustrated, the operations 200 begin at block 210 with generating a plurality of parameters for a machine learning model based on a training data set.

At block 220, the operations 200 proceed with calculating characteristics for one or more parameters from the plurality of parameters for the machine learning model.

At block 230, the operations 200 proceed with setting, for each respective parameter of the one or more parameters, a corresponding characteristic as a constant for processing values of the respective parameter.

At block 240, the operations 200 proceed with generating a normalized machine learning model based on the one or more parameters and the corresponding characteristic for each respective parameter of the one or more parameters.

At block 250, the operations 200 proceed with deploying the normalized machine learning model. Generally, the machine learning model normalizes values generated for an input based on the constants.

In some aspects, the characteristics for the one or more parameters include a mean and a standard deviation associated with inputs into a portion of the machine learning model.

In some aspects, the machine learning model may be a transformer neural network including at least one self-attention block. Keys and queries in the self-attention block may correspond to the inputs into the portion of the machine learning model, and values may be generated as an output of the at least one self-attention block. The one or more characteristics comprise a first mean and a first standard deviation associated with the keys and a second mean and a second standard deviation associated with the queries.

In some aspects, the inputs may comprise tokens derived from exemplar images in the training data set. In such a case, each image in the training data set may be projected into a plurality of tokens. Each token may represent a specific portion (e.g., pixel or group of pixels) within a specific exemplar image in the training data set.

In some aspects, the normalized machine learning model may be configured to normalize the values generated for the input while convolving the input. In such a case, the normalization may be folded into other mathematical operations performed by the portion of the machine learning model such that normalization is performed as one or more matrix multiplication and addition operations.

In some aspects, the normalized machine learning model may be configured to normalize the values generated for the input while applying a linear operation to the input (e.g., as part of a linear operation used to generate an output of the machine learning model).

In some aspects, the normalized machine learning model does not include a normalizing block that processes a result of one or more layers in the machine learning model. For example, in a transformer neural network, the normalized machine learning model may omit softmax or other activation function blocks that normalize an output of a portion of a neural network or an input into the portion of the neural network.

In some aspects, the constant may include a scaling constant and a shifting constant learned from the training data set.

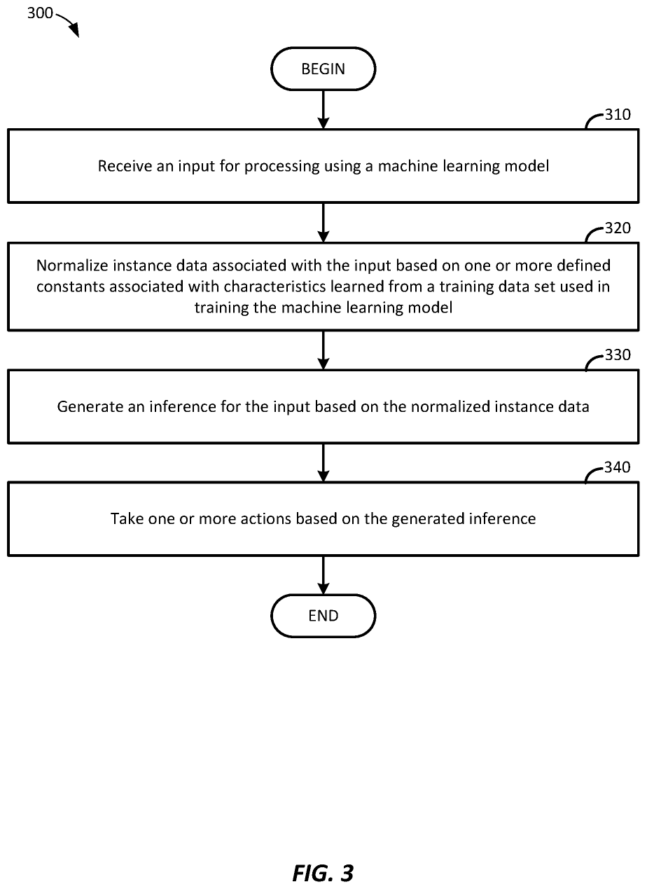

FIG. 3 illustrates example operations 300 for inferencing using a machine learning model to generate normalized outputs based on learned normalization constants, according to aspects of the present disclosure. The operations 300 may be performed, for example, using the machine learning model 100 illustrated in FIG. 1.

As illustrated, the operations 300 may begin at block 310 with receiving an input for processing using the machine learning model.

At block 320, the operations 300 proceed with normalizing instance data associated with the input based on one or more defined constants associated with characteristics learned from a training data set used in training the machine learning model.

In some aspects, the characteristics learned from the training data set include a mean and a standard deviation associated with the training data set. As discussed, because the characteristics learned from the training data set may be set as constants for use in normalizing instance data associated with an input (which may be within a range of inputs expected to be processed using the machine learning model and included in the training data set), statistical information used in normalizing inputs into the machine learning model need not be derived from the instance data itself. Thus, by using a-priori-defined constants to normalize instance data associated with an input, aspects of the present disclosure may minimize, or at least reduce, the likelihood of memory thrashing that may be experienced when normalizing an input based on statistics associated with the input itself.

At block 330, the operations 300 proceed with generating an inference for the input based on the normalized instance data.

At block 340, the operations proceed with taking one or more actions based on the generated inference. In one example, the one or more actions may include generating one or more control signals to control an autonomous vehicle based on an inference including information identifying objects along the path of travel of the autonomous vehicle and/or predicted movement of these identified objects. In one example, the one or more actions may include generating one or more control signals to control a robot based on an inference including information identifying a future path of travel of the robot and predicted proximity to other objects within the operating environment of the robot. In one example, the one or more actions may include compressing video content using different levels of compression based on an inference including information identifying objects or regions of interest within a scene and objects or regions of lesser importance within the scene. It should be recognized that the foregoing are examples of actions that may be performed based on an inference, and that other actions may be performed based on the operating environment and purpose for which a machine learning model is deployed.

In some aspects, the machine learning model may be a transformer neural network. The one or more defined constants may be constants associated with a self-attention layer of the transformer neural network. For example, the one or more defined constants may include a first mean and a first standard deviation associated with keys of the transformer neural network and a second mean and a second standard deviation associated with queries serving as inputs into the transformer neural network.

In some aspects, the machine learning model does not include a normalizing block that processes an intermediate output of the machine learning model to generate the inference.

In some aspects, the instance data associated with the input may include tokens derived from an input image to be processed using the machine learning model.

In some aspects, the generated inference may include an identification of one or more objects within an image input into the machine learning model. In such a case, the one or more actions may include controlling an autonomous vehicle to avoid a collision with the one or more objects within the image.

In some aspects, the defined constants may include a scaling constant and a shifting constant learned from the training data set.

### Example Processing System for Training and Inferencing Using Machine Learning Models and Learned Normalizing Constants

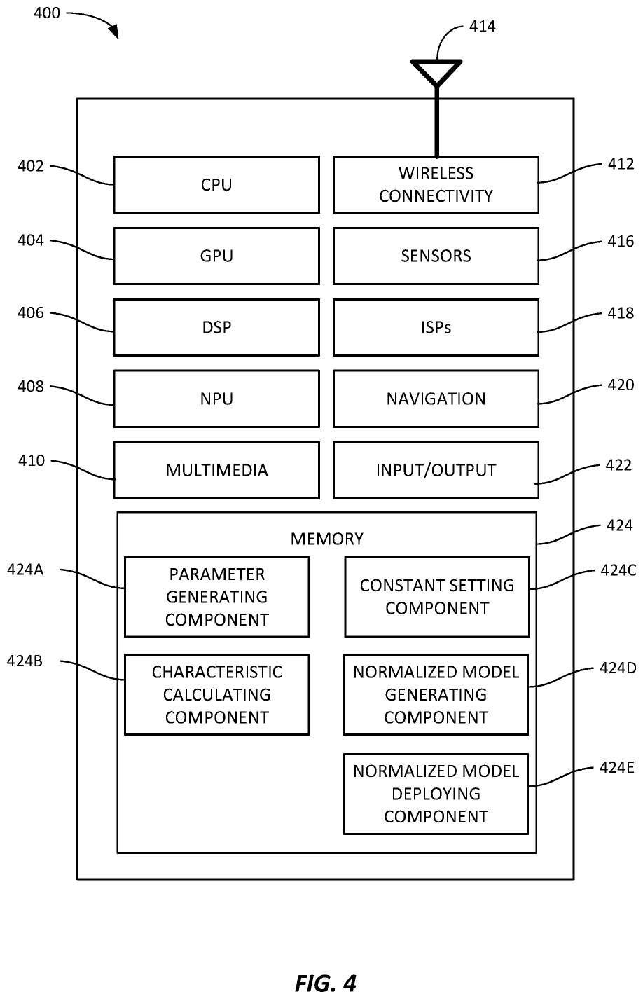

FIG. 4 depicts an example processing system 400 configured to perform various aspects of the present disclosure, including, for example, the techniques and methods described with respect to FIGS. 1-3. In some aspects, the processing system 400 may train, implement, or provide a machine learning model, such as the machine learning model 100 of FIG. 1. Although depicted as a single system for conceptual clarity, in at least some aspects, as discussed above, the operations described below with respect to the processing system 400 may be distributed across any number of devices.

The processing system 400 includes a central processing unit (CPU) 402, which in some examples may be a multi-core CPU. Instructions executed at the CPU 402 may be loaded, for example, from a program memory associated with the CPU 402 or may be loaded from a partition of memory 424.

The processing system 400 also includes additional processing components tailored to specific functions, such as a graphics processing unit (GPU) 404, a digital signal processor (DSP) 406, a neural processing unit (NPU) 408, a multimedia processing unit 410, and a wireless connectivity component 412.

An NPU, such as NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 408 is a part of one or more of the CPU 402, the GPU 404, and/or the DSP 406.

In some examples, the wireless connectivity component 412 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 412 is further coupled to one or more antennas 414.

The processing system 400 may also include one or more sensor processing units 416 associated with any manner of sensor, one or more image signal processors (ISPs) 418 associated with any manner of image sensor, and/or a navigation component 420, which may include satellite-based positioning system components (e.g., GPS or GLONASS) as well as inertial positioning system components.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

The processing system 400 also includes the memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes a parameter generating component 424A, a characteristic calculating component 424B, a constant setting component 424C, a normalized model generating component 424D, and a normalized model deploying component 424E. Though depicted as discrete components for conceptual clarity in FIG. 4, the illustrated components (and others not depicted) may be collectively or individually implemented in various aspects.

Generally, the processing system 400 and/or components thereof may be configured to perform the methods described herein.

Notably, in other aspects, aspects of the processing system 400 may be omitted, such as where the processing system 400 is a server computer or the like. For example, the multimedia processing unit 410, the wireless connectivity component 412, the sensor processing units 416, the ISPs 418, and/or the navigation component 420 may be omitted in other aspects. Further, aspects of the processing system 400 may be distributed between multiple devices.

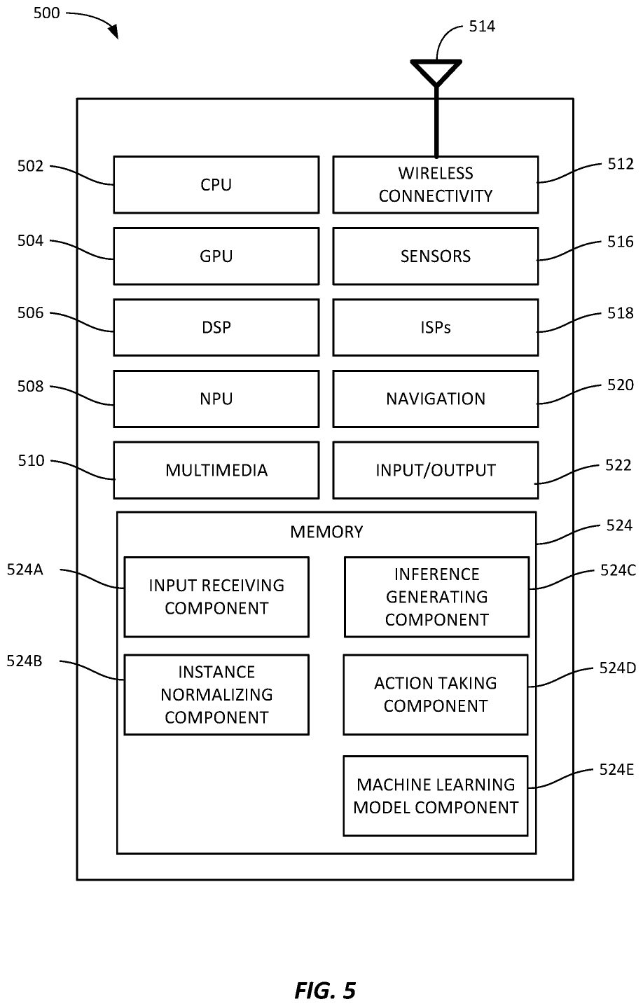

FIG. 5 depicts an example processing system 500 configured to perform various aspects of the present disclosure, including, for example, the techniques and methods described with respect to FIGS. 1-3. In some aspects, the processing system 500 may generate inferences using a machine learning model, such as the machine learning model 100 of FIG. 1. Although depicted as a single system for conceptual clarity, in at least some aspects, as discussed above, the operations described below with respect to the processing system 500 may be distributed across any number of devices.

The processing system 500 includes a central processing unit (CPU) 502, which in some examples may be a multi-core CPU. Instructions executed at the CPU 502 may be loaded, for example, from a program memory associated with the CPU 502 or may be loaded from a partition of memory 524.

The processing system 500 also includes additional processing components tailored to specific functions, such as a graphics processing unit (GPU) 504, a digital signal processor (DSP) 506, a neural processing unit (NPU) 508, a multimedia processing unit 510, and a wireless connectivity component 512.

In some implementations, the NPU 508 is a part of one or more of the CPU 502, the GPU 504, and/or the DSP 506.

In some examples, the wireless connectivity component 512 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 512 is further coupled to one or more antennas 514.

The processing system 500 may also include one or more sensor processing units 516 associated with any manner of sensor, one or more image signal processors (ISPs) 518 associated with any manner of image sensor, and/or a navigation component 520, which may include satellite-based positioning system components (e.g., GPS or GLONASS) as well as inertial positioning system components.

The processing system 500 may also include one or more input and/or output devices 522, such as screens, touch-sensitive surfaces (including touch-sensitive displays), physical buttons, speakers, microphones, and the like.

In some examples, one or more of the processors of the processing system 500 may be based on an ARM or RISC-V instruction set.

The processing system 500 also includes the memory 524, which is representative of one or more static and/or dynamic memories, such as a dynamic random access memory, a flash-based static memory, and the like. In this example, the memory 524 includes computer-executable components, which may be executed by one or more of the aforementioned processors of the processing system 500.

In particular, in this example, the memory 524 includes an input receiving component 524A, an instance data normalizing component 524B, an inference generating component 524C, an action taking component 524D, and a machine learning model component 524E. Though depicted as discrete components for conceptual clarity in FIG. 5, the illustrated components (and others not depicted) may be collectively or individually implemented in various aspects.

Generally, the processing system 500 and/or components thereof may be configured to perform the methods described herein.

Notably, in other aspects, aspects of the processing system 500 may be omitted, such as where the processing system 500 is a server computer or the like. For example, the multimedia processing unit 510, the wireless connectivity component 512, the sensor processing units 516, the ISPs 518, and/or the navigation component 520 may be omitted in other aspects. Further, aspects of the processing system 500 may be distributed between multiple devices.

### Example Clauses

Implementation details of various aspects of the present disclosure are described in the following numbered clauses:
Clause 1: A processor-implemented method, comprising: receiving an input for processing using a machine learning model; normalizing instance data associated with the input based on one or more defined constants associated with characteristics learned from a training data set used in training the machine learning model; generating an inference for the instance data associated with the input based on the normalized input; and taking one or more actions based on the generated inference.
Clause 2: The method of Clause 1, wherein the characteristics comprise a mean and a standard deviation associated with the training data set.
Clause 3: The method of Clause 1 or 2, wherein the machine learning model comprises a transformer neural network and wherein the one or more defined constants comprise constants associated with a self-attention layer of the transformer neural network.
Clause 4: The method of Clause 3, wherein the one or more defined constants comprise: a first mean and a first standard deviation associated with keys of the transformer neural network, and a second mean and a second standard deviation associated with queries serving as inputs into the transformer neural network.
Clause 5: The method of any of Clauses 1 through 4, wherein the machine learning model does not include a normalizing block that processes an intermediate output of the machine learning model to generate the inference.
Clause 6: The method of any of Clauses 1 through 5, wherein the instance data associated with the input comprises tokens derived from an input image to be processed using the machine learning model.
Clause 7: The method of any of Clauses 1 through 6, wherein the generated inference comprises an identification of one or more objects within an image input into the machine learning model.
Clause 8: The method of Clause 7, wherein the one or more actions comprises controlling an autonomous vehicle to avoid a collision with the one or more objects within the image.
Clause 9: The method of any of Clauses 1 through 8, wherein the defined constants comprise a scaling constant and a shifting constant learned from the training data set.
Clause 10: A processor-implemented method, comprising: generating a plurality of parameters for a machine learning model based on a training data set; calculating characteristics for one or more parameters from the plurality of parameters for the machine learning model; for each respective parameter of the one or more parameters, setting a corresponding characteristic as a constant for processing values of the respective parameter; generating a normalized machine learning model based on the one or more parameters and the corresponding characteristic for each respective parameter of the one or more parameters; and deploying the normalized machine learning model, wherein the machine learning model normalizes values generated for an input based on the constants.
Clause 11: The method of Clause 10, wherein the characteristics for the one or more parameters comprise a mean and a standard deviation associated with inputs into a portion of the machine learning model.
Clause 12: The method of Clause 11, wherein: the machine learning model comprises a transformer neural network including at least one self-attention block into which keys and queries correspond to the inputs into the portion of the machine learning model and values are generated as an output of the at least one self-attention block, and the one or more parameters comprise a first mean and a first standard deviation associated with the keys and a second mean and a second standard deviation associated with the queries.
Clause 13: The method of any of Clauses 10 through 12, wherein the inputs comprise tokens derived from exemplar images in a training data set.
Clause 14: The method of any of Clauses 10 through 13, wherein the normalized machine learning model is configured to normalize the values generated for the input while convolving the input.
Clause 15: The method of any of Clauses 10 through 14, wherein the normalized machine learning model is configured to normalize the values generated for the input while applying a linear operation to the input.
Clause 16: The method of any of Clauses 10 through 15, wherein the normalized machine learning model does not include a normalizing block that processes a result of one or more layers in the machine learning model.
Clause 17: The method of any of Clauses 10 through 16, wherein the constant comprises a scaling constant and a shifting constant learned from the training data set.
Clause 18: A processing system comprising: a memory comprising computer-executable instructions; and one or more processors configured to execute the computer-executable instructions and cause the processing system to perform a method in accordance with any of Clauses 1-17.
Clause 19: A processing system comprising means for performing a method in accordance with any of Clauses 1-17.
Clause 20: A non-transitory computer-readable medium comprising computer-executable instructions that, when executed by one or more processors of a processing system, cause the processing system to perform a method in accordance with any of Clauses 1-17.
Clause 21: A computer program product embodied on a computer-readable storage medium comprising code for performing a method in accordance with any of Clauses 1-17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions in order to cause the processing system to:
receive an input for processing using a machine learning model;
normalize instance data associated with the input based on one or more defined constants associated with characteristics learned from a training data set used in training the machine learning model;
generate an inference for the input based on the normalized instance data; and
take one or more actions based on the generated inference.

2. The processing system of claim 1, wherein the characteristics comprise a mean and a standard deviation associated with the training data set.

3. The processing system of claim 1, wherein the machine learning model comprises a transformer neural network, and wherein the one or more defined constants comprise constants associated with a self-attention layer of the transformer neural network.

4. The processing system of claim 3, wherein the one or more defined constants comprise:
a first mean and a first standard deviation associated with keys of the transformer neural network, and
a second mean and a second standard deviation associated with queries serving as inputs into the transformer neural network.

5. The processing system of claim 1, wherein the machine learning model does not include a normalizing block that processes an intermediate output of the machine learning model to generate the inference.

6. The processing system of claim 1, wherein the instance data associated with the input comprises tokens derived from an input image to be processed using the machine learning model.

7. The processing system of claim 1, wherein the generated inference comprises an identification of one or more objects within an image input into the machine learning model.

8. The processing system of claim 7, wherein the one or more actions comprises controlling an autonomous vehicle to avoid a collision with the one or more objects within the image.

9. The processing system of claim 1, wherein the defined constants comprise a scaling constant and a shifting constant learned from the training data set.

10. A processing system, comprising:
at least one memory having executable instructions stored thereon; and
one or more processors configured to execute the executable instructions in order to cause the processing system to:
generate a plurality of parameters for a machine learning model based on a training data set;
calculate characteristics for one or more parameters from the plurality of parameters for the machine learning model;
set, for each respective parameter of the one or more parameters, a corresponding characteristic as a constant for processing values of the respective parameter;
generate a normalized machine learning model based on the one or more parameters and the corresponding characteristic for each respective parameter of the one or more parameters; and
deploy the normalized machine learning model, wherein the normalized machine learning model normalizes values generated for instance data associated with an input based on the constants.

11. The processing system of claim 10, wherein the characteristics for the one or more parameters comprise a mean and a standard deviation associated with instance data associated with inputs into a portion of the machine learning model.

12. The processing system of claim 11, wherein:
the machine learning model comprises a transformer neural network including at least one self-attention block into which keys and queries correspond to the inputs into the portion of the machine learning model and values are generated as an output of the at least one self-attention block, and
the one or more parameters comprise a first mean and a first standard deviation associated with the keys and a second mean and a second standard deviation associated with the queries.

13. The processing system of claim 10, wherein the instance data associated with inputs comprise tokens derived from exemplar images in the training data set.

14. The processing system of claim 10, wherein the normalized machine learning model is configured to normalize the values generated for the instance data associated with the input while convolving the instance data associated with the input.

15. The processing system of claim 10, wherein the normalized machine learning model is configured to normalize the values generated for instance data associated with an input while applying a linear operation to the input.

16. The processing system of claim 10, wherein the normalized machine learning model does not include a normalizing block that processes a result of one or more layers in the machine learning model.

17. The processing system of claim 10, wherein the constant comprises a scaling constant and a shifting constant learned from the training data set.

18. A processor-implemented method, comprising:
receiving an input for processing using a machine learning model;
normalizing instance data associated with the input based on one or more defined constants associated with characteristics learned from a training data set used in training the machine learning model;
generating an inference for the input based on the normalized instance data; and
taking one or more actions based on the generated inference.

19. The method of claim 18, wherein the characteristics comprise a mean and a standard deviation associated with the training data set.

20. The method of claim 18, wherein the machine learning model comprises a transformer neural network and wherein the one or more defined constants comprise constants associated with a self-attention layer of the transformer neural network.

21. The method of claim 20, wherein the one or more defined constants comprise:
a first mean and a first standard deviation associated with keys of the transformer neural network, and
a second mean and a second standard deviation associated with queries serving as inputs into the transformer neural network.

22. The method of claim 18, wherein the machine learning model does not include a normalizing block that processes an intermediate output of the machine learning model to generate the inference.

23. The method of claim 18, wherein the instance data associated with the input comprises tokens derived from an input image to be processed using the machine learning model.

24. The method of claim 18, wherein the generated inference comprises an identification of one or more objects within an image input into the machine learning model.

25. The method of claim 24, wherein the one or more actions comprises controlling an autonomous vehicle to avoid a collision with the one or more objects within the image.

26. The method of claim 18, wherein the defined constants comprise a scaling constant and a shifting constant learned from the training data set.

27. A processor-implemented method, comprising:
generating a plurality of parameters for a machine learning model based on a training data set;
calculating characteristics for one or more parameters from the plurality of parameters for the machine learning model;
for each respective parameter of the one or more parameters, setting a corresponding characteristic as a constant for processing values of the respective parameter;
generating a normalized machine learning model based on the one or more parameters and the corresponding characteristic for each respective parameter of the one or more parameters; and
deploying the normalized machine learning model, wherein the machine learning model normalizes values generated for instance data associated with an input based on the constants.

28. The method of claim 27, wherein the characteristics for the one or more parameters comprise a mean and a standard deviation associated with instance data associated with inputs into a portion of the machine learning model.

29. The method of claim 28, wherein:
the machine learning model comprises a transformer neural network including at least one self-attention block into which keys and queries correspond to the instance associated with inputs into the portion of the machine learning model and values are generated as an output of the at least one self-attention block, and
the one or more parameters comprise a first mean and a first standard deviation associated with the keys and a second mean and a second standard deviation associated with the queries.

30. The method of claim 27, wherein the normalized machine learning model does not include a normalizing block that processes a result of one or more layers in the machine learning model.
